(19) United States
(12) Patent Application Publication
(10) Pub. No.: US 2020/0344358 A1
(43) Pub. Date: Oct. 29, 2020

(54) System and Process for Implementing a Virtual Airtime Card for Wireless Services

(71) Applicant: TracFone Wireless, Inc., Miami, FL (US)

(72) Inventors: Wendy Harris, Miami, FL (US); James Zimmerman, Miami, FL (US); Edward Serpa, Miami, FL (US); Maria Pena, Miami, FL (US); Zhong Yang, Miami, FL (US)

(21) Appl. No.: 16/858,970

(22) Filed: Apr. 27, 2020

Related U.S. Application Data
(60) Provisional application No. 62/839,276, filed on Apr. 26, 2019.

(51) Int. Cl. H04M 15/00; H04W 4/24; G06Q 20/32; G06Q 20/28; H04M 17/00; H04W 60/00; H04W 8/18

(52) U.S. Cl. CPC H04M 15/61; H04W 4/24; G06Q 20/3276; H04W 8/18; H04M 17/304; H04W 60/00; G06Q 20/28

(57) ABSTRACT

A wireless service provider system for authorizing wireless service on a wireless device, where the wireless device includes a processor configured to implement a virtual airtime card application, a camera configured to capture an image of an airtime card code, and the processor further configured to implement the virtual airtime card application to generate a virtual airtime card based on the image of the airtime card code.

### CROSS-REFERENCE TO RELATED APPLICATIONS

This application claims the benefit of U.S. Provisional Application No. 62/839,276 filed on Apr. 26, 2019, which is hereby incorporated by reference in its entirety for all purposes as if fully set forth herein.

### BACKGROUND OF THE DISCLOSURE

### 1. Field of the Disclosure

The disclosure relates to a system implementing a virtual card having a value that may be utilized for obtaining services. The disclosure further relates to a process for implementing a virtual card having a value that may be utilized for obtaining services. The disclosure further relates to a system implementing a virtual card having a prepaid monetary value that may be utilized for obtaining services. The disclosure further relates to a process for implementing a virtual card having a prepaid monetary value that may be utilized for obtaining services.

The disclosure further relates to a system implementing a virtual card having a value that may be utilized for obtaining wireless services. The disclosure further relates to a process for implementing a virtual card having a value that may be utilized for obtaining wireless services. The disclosure further relates to a system implementing a virtual card having a prepaid monetary value that may be utilized for obtaining wireless services. The disclosure further relates to a process for implementing a virtual card having a prepaid monetary value that may be utilized for obtaining wireless services.

### 2. Related Art

A large number of wireless service plans exist for customers desiring wireless services such as voice call service, data service, and/or text messaging service. To obtain these wireless services, customers generally have the option of entering into a post-paid service, e.g., contract for a period of time, or a pre-paid, contract-free service. The latter offers customers the freedom to initiate and stop wireless services without incurring expensive cancellation fees associated with a post-paid service.

Generally, companies that provide post-paid wireless services are wireless carriers or Mobile Network Operators (MNOs) that maintain and control their own wireless networks. A MNO heavily relies on backend systems to address any provisional, billing, security, and data issues that might threaten the health of their networks. On the other hand, a Mobile Virtual Network Operator (MVNO) is a mobile operator that typically does not own its own frequency spectrum or have its own network infrastructure. MVNOs negotiate and enter into business agreements with third party wireless carriers or MNOs to purchase the right to use their networks for wireless services including volume of data, number of voice minutes, and number of text messages used.

The wireless services provided by the MVNOs often implement physical activation cards, also known as airtime cards, for the sale of wireless service, e.g. voice call service, data service, and/or text messaging service. Airtime cards typically have preset amounts of voice call service, data service, text messaging service, and/or days. Airtime cards generally include a physical form factor that typically includes a unique code and may include a scratch off area obscuring the unique code. When these codes are Point-Of-Sale activated, the code will provide pre-designated wireless benefits (i.e. an amount of voice call service, data service, text messaging service, and/or wireless service days), along with authorizing a phone with a unique IMEI or serial number to be carrier-activated.

The physical airtime cards are typically displayed for sale at a retailer. Common problems with physical airtime cards include: managing an inventory of the airtime cards, wireless benefits offering changes for the airtime cards, price-point changes of the airtime cards, managing multiple airtime cards with various combinations or wireless benefits offerings, and/or the like. In addition, due to retailers having limited space, there is a need to combine various types of airtime cards into one airtime card. A common way that this occurs is by having numerous unique codes on a single airtime card, or a unique code on a single airtime card with numerous wireless benefits offerings where one of the wireless benefits is assigned to the unique code at the Point-Of-Sale Activation event. The specific unique code is activated through the point-of-sale activation system of retailers.

Accordingly, a more convenient flexible approach is needed for the sale and procuring of wireless services that provide improvements to managing inventory of the airtime cards, wireless benefits offering changes for the airtime cards, price-point changes of the airtime cards, and/or managing multiple airtime cards with various combinations or wireless benefits offerings.

### SUMMARY OF THE DISCLOSURE

The disclosure provides a more convenient flexible approach for the sale and procuring of wireless services with a virtual airtime card. The disclosed concept of the virtual airtime card provides flexibility of wireless benefits, price-point, artwork, other physical product changes, and/or the like; while improving inventory management and availability of airtime cards. Among the benefits described below, it should be noted that a benefit of a virtual airtime card is the ability to use various payment mechanisms, including cash, store gift cards, and/or the like to purchase airtime.

Although the disclosure focuses on generating a virtual airtime card for wireless services, the concepts described herein may be equally utilized for virtual cards providing any type of service, any type of purchase of goods, and/or the like. The focus on a virtual airtime card for wireless services is simply a particular non-limiting aspect. As described herein a virtual airtime card is an airtime card not physically existing as such but enabled by software to appear to do so, an airtime card carried out, accessed, and/or stored by means of a computer, a nonphysical airtime card, an airtime card existing within a wireless device, an airtime card displayed on a display of the wireless device, an airtime card simulated by a wireless device, and/or the like. In this regard, a physical airtime card may be a physical medium such as a paper medium, a plastic medium, and/or the like that may have alphanumeric printing thereon and may have a card shaped form factor. As described herein a virtual airtime card is different from and has numerous benefits in comparison to a physical airtime card.

Convenience, timeliness, and reliability of wireless providers' are key factors that play into a user's experience. By developing a system to improve at least these factors, a more positive experience can be provided to the user. The improved experience will help retain customer base and increase the number of customers willing to purchase wireless services from MNOs and MVNOs. In order to do so, the following needs can be addressed by enabling new improved systems that can be implemented for the distribution of a wireless service through a virtual airtime card.

The foregoing needs are met, to a great extent, by the disclosure, providing a system and associated methods for implementing a virtual airtime card for wireless services. In particular, the disclosure is intended to solve the challenges of using preset monetary values and associated preset amounts of wireless service. According to some aspects of the disclosure, the wireless services may include at least one of voice call service, data service, text messaging service, and/or service days.

One aspect includes a wireless service provider system for authorizing wireless service on a wireless device, the wireless device includes: a processor configured to implement a virtual airtime card application; a camera configured to capture an image of an airtime card code; the processor further configured to implement the virtual airtime card application to generate a virtual airtime card based on the image of the airtime card code; and a display configured to display the virtual airtime card generated by the processor, where: the virtual airtime card displayed on the display of the wireless device is configured to be purchased with at least one of the following: a point-of-sale or through a payment process implemented by the virtual airtime card application.

One aspect includes a wireless service provider system that includes: a backend system configured to be in communication with a connected device; the backend system further configured to receive a request to activate at least one code of a virtual airtime card from the connected device; the backend system further configured to receive a request to authorize wireless service for a wireless device in response to receiving the at least one code of the virtual airtime card; a metering system configured to monitor a use of the wireless service provided by a wireless service provider used by the wireless device; and the metering system further configured to control the use of the wireless service provided by the wireless service provider used by the wireless device, where the wireless device that includes a processor configured to implement a virtual airtime card application to generate the virtual airtime card based on an image of an airtime card code, and where the connected device that includes one of the following: a point-of-sale terminal, the wireless device, or an Internet-enabled device.

One aspect includes a non-transitory computer program product embodying instructions for implementing a process for authorizing wireless service on a wireless device when executed by a processor of the wireless device, the instructions that includes: implementing a virtual airtime card application in the processor of the wireless device; capturing an image of an airtime card code with a camera from the wireless device; generating a virtual airtime card based on the image of the airtime card code with the processor and displaying the virtual airtime card generated by the processor on a display of the wireless device, where: the virtual airtime card displayed on the display of the wireless device is configured to be purchased with at least one of the following: a point-of-sale or through a payment process implemented by the virtual airtime card application, the virtual airtime card that includes at least one code configured to be provided to a wireless service provider system to provision wireless service to a wireless device.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will also form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

The above mentioned features and aspects of the disclosure will become more apparent with reference to the following description taken in conjunction with the accompanying drawings wherein like reference numerals denote like elements and in which:

FIG. 1 illustrates a block diagram of a wireless device with exemplary components in accordance with aspects of the disclosure.

FIG. 2 illustrates a schematic diagram of exemplary virtual airtime card generation scenarios in accordance with aspects of the disclosure.

FIG. 3 illustrates a graphical user interface in accordance with aspects of the disclosure.

FIG. 4 illustrates a graphical user interface in accordance with aspects of the disclosure.

FIG. 5 illustrates an exemplary process that may be used to implement the system of the disclosure.

FIG. 6 illustrates a graphical user interface for displaying a virtual airtime card in accordance with aspects of the disclosure.

FIG. 7 illustrates an exemplary system according to aspects of the disclosure.

### DETAILED DESCRIPTION

In this specification and claims it is to be understood that reference to a wireless device is intended to encompass electronic devices such as mobile phones, tablet computers, gaming systems, MP3 players, personal computers, PDAs, and the like. A “wireless device” is intended to encompass any compatible mobile technology computing device that can connect to a wireless communication network, such as mobile phones, mobile equipment, mobile stations, user equipment, cellular phones, smartphones, handsets, or the like (e.g., Apple iPhone, Google Android based devices, BlackBerry based devices, other types of PDAs or smartphones), wireless dongles, remote alert devices, or other mobile computing devices that may be supported by a wireless network. The term “wireless device” may be interchangeably used and referred to herein as “wireless handset,” “handset,” “mobile device,” “device,” “mobile phones,” “mobile equipment,” “mobile station,” “user equipment,” “cellular phone,” “smartphones,” “monitoring device” or “phone.”

A “point-of-sale” terminal as used herein can refer to a location where one or more wireless devices and/or services can be sold and/or activated which may or may not require sales personnel. A point-of-sale terminal can include, for example, a vending machine, an automated kiosk, a retail store, a convenience store, a gas station, and/or the like.

Wireless devices may connect to a “wireless network” or “network” and are intended to encompass any type of wireless network to obtain or provide mobile phone services through the use of a wireless device, such as the Global System for Mobile Communication (GSM) network, a Code-Division Multiple Access (CDMA) network, a Long-Term Evolution (LTE) network, a 3G network, a 4G network, a 5G network, that may utilize the teachings of the present application to sell, activate, monitor, redeem, authorize, and/or track, the provisioning of one or more wireless services.

Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described, which may be requirements for some aspects but not for other aspects.

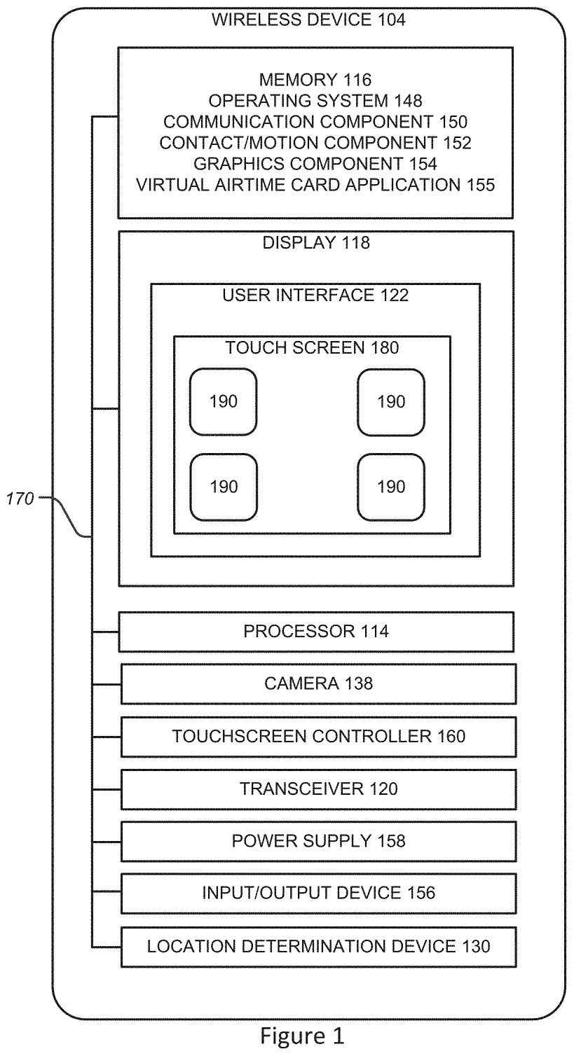

FIG. 1 illustrates a block diagram of a wireless device with exemplary components in accordance with aspects of the disclosure.

The wireless device 104 may include a processor 114, a memory 116, a transceiver 120, and a user interface 122. The processor 114 may be a central processing unit configured to execute instructions such as instructions related to software programs. Any processor can be used for the wireless device 104 as understood to those of ordinary skill in the art. In one aspect, the processor 114 may be a microprocessor, a chipset, or the like.

The wireless device 104 may include a camera 138 that is multifunctional. The camera 138 may be used to capture images such as of a person or place, biometric readings such as a fingerprint or a retina, letters, symbols, and numbers (optical character reading/machine code reading), an image of a machine code, which may include a bar code such as a QR code, a Data Matrix (DM) code, a Universal Product Code (UPC), and/or the like. The camera 138 may be on the front, back, sides and/or the like of the wireless device 104.

The camera 138 may include a charge coupled device (CCD), CMOS image sensors, Back Side Illuminated CMOS, and/or the like. Images captured by the camera 138 may be converted and stored in various formats including a JPEG file format, RAW feature format such as the Android (operating system) 5.0 Lollipop, and/or the like. Additionally, the wireless device 104 may include an application for display of images captured by the camera 138.

In a particular aspect, the camera 138 may include functionality as a barcode reader, a Data Matrix code reader, a QR code reader, and/or the like. A QR code (Quick Response Code) is a type of matrix barcode (or two-dimensional barcode). The matrix barcode may be a machine-readable optical label that contains information about the item to which it is attached. A QR code uses a number of standardized encoding modes including numeric, alphanumeric, byte/binary, and the like to efficiently store data. The QR code may include black modules arranged in a square grid on a white background, which can be read by the camera 138 or other imaging device and processed using, for example, Reed-Solomon error correction until the image can be appropriately interpreted. The required data may then be extracted from patterns that are present in both horizontal and vertical components of the image.

In a particular aspect, the camera 138 may include functionality as a Data Matrix code reader. A Data Matrix code is a two-dimensional matrix barcode (machine-readable) including black and white “cells” or modules arranged in either a square or rectangular pattern. The Data Matrix code may be implemented with the ECC 200 version of Data Matrix and include Reed-Solomon codes for error and erasure recovery. Other protocols and/or versions of the Data Matrix are contemplated as well.

In a particular aspect, the camera 138 may include functionality as a Universal Product Code (UPC) reader. The UPC is a barcode symbology utilizing protocols such as UPC-A, UPC-E, European Article Number (EAN), UPC-B, UPC-C UPC-D, UPC-2, UPC-5, and/or the like type machine-readable codes.

The camera 138 can be in communication with the processor 114, the memory 116, and the user interface 122. Moreover, the camera 138 may be in direct communication with an analog to digital converter. Accordingly, the camera 138 may capture the machine readable code, such as the bar code, the QR code, the Data Matrix, and/or the like and generate an analog signal. The analog signal may be converted to a digital signal for processing by the processor 114. The processor 114 may be a central processing unit configured to execute instructions such as instructions related to software programs. Any processor such as a microprocessor, Field-Programmable Gate Array (FPGA), an Application Specific Integrated Circuits (ASIC), a controller, a chipset, a System-on-a-Chip (SoC), a Central Processing Unit (CPU), a Graphics Processing Unit (GPU), an Image Processing Unit (ISP), a Digital Signal Processor (DSP), a Neural Processing Unit (NPU), a Video encoder/decoder, a Modem, and/or the like can be used in the wireless device 104 as understood to those of ordinary skill in the art.

The display 118 may be a liquid crystal display (LCD), light-emitting diode (LED) display, or the like. The display 118 may include a backlight to illuminate the various color liquid crystals to provide a more colorful display. The user interface 122 may be any type of physical input as readily employed in the field. For example, the user interface 122 may have physical buttons. Alternatively, the user interface 122 may be implemented on a touchscreen 180, a motion sensor (not shown), and the like. Finally, the wireless device 104 may include a power supply 158.

The memory 116 of the wireless device 104 may include an operating system 148, a communication component 150, a contact/motion component 152, a graphics component 154, and/or the like. The operating system 148 together with the various components may provide software functionality for each of the components of the wireless device 104. The memory 116 may include a high-speed, random-access memory. Also, the memory 116 may be a non-volatile memory, such as magnetic fixed disk storage, a Subscriber Identity Module (SIM), a Universal Integrated Circuit Card (UICC), a cloud-based memory, a flash memory and/or the like. These various components may be connected through various communication lines including a data bus 170. In further aspect of the disclosure, the memory 116 of the wireless device 104 may include a virtual airtime card application 155.

The wireless device 104 can include an audio input/output device 156. The audio input/output device 156 may include speakers, speaker outputs, and/or the like, providing sound output; and may include microphones, microphone inputs, and/or the like, for receiving sound inputs. In an exemplary aspect, the audio input/output device 156 may include an analog to digital converter and a digital to audio converter for audio input and output functions respectively.

In some aspects, the wireless device 104 may implement geolocation and/or estimate a location of the wireless device 104 based, at least in part, on a global navigation satellite system (GNSS) with a location determination device 130. In another aspect, a wireless network may secure location determination based on a specific cell in which the wireless device 104 connects. In yet another aspect, a wireless network may obtain location determination based on triangulation with respect to a plurality of cells in which the wireless device 104 receives signals and/or transmit signals. In one aspect, the location of the wireless device 104 may be provided to the virtual airtime card application 155 from the location determination device 130, the wireless network, and/or the processor 114.

The transceiver 120 and/or the processor 114 may provide radio and signal processing as needed to access a wireless network for services. The transceiver 120 and/or the processor 114 may be configured to process call functions, data transfer, and/or the like and provide an array of services, based on those functions, to the user.

In an exemplary aspect, the touchscreen 180 of the disclosure may be implemented in the display 118 and may detect a presence and location of a touch of a user within the display area. For example, touching the display 118 of the wireless device 104 with a finger or hand. The touchscreen 180 may also sense other passive objects, such as a stylus. Additionally, the wireless device 104 may further include a touch screen controller 160.

In one operation, the display 118 may show various objects 190 associated with applications for execution by the processor 114. For example, a user may touch the display 118, particularly the touchscreen 180, to interact with the objects 190. That is, touching an object 190 may execute an application in the processor 114 associated with the object 190 that is stored in memory 116. Additionally or alternatively, touching an object 190 may open a menu of options to be selected by the user. The display 118 may include a plurality of objects 190 for the user to interact with. Moreover, the display 118 may include a plurality of screens. The display 118 showing one screen at a time. The user may interact with the display 118 to move a screen into view on the display 118. Various objects 190 may be located in each of the screens. The touchscreen 180 may be implemented as a resistive touchscreen, a surface acoustic wave touch screen, a capacitive touchscreen, self-capacitance sensors, infrared sensors, dispersive signal technology, acoustic pulse recognition, or the like.

The display 118 is generally configured to display a user interface 122 and/or graphical user interface (GUI) that provides an easy to use visual interface between a user of the wireless device 104 and the operating system or application(s) running on the wireless device 104. Generally, the GUI presents programs, files, and/or operational options with graphical images. During operation, the user may select and activate various graphical images displayed on the display 118 in order to initiate functions and tasks associated therewith.

In another aspect of the disclosure, the memory 116 of the wireless device 104 can include a database for storing user information. The user information may include information such as full name, address, email address, contact number, credit card information, and/or the like. In one aspect, the database may include security questions. In another aspect, the database may include user specified preferences.

In further aspect of the disclosure, the memory 116 of the wireless device 104 includes the virtual airtime card application 155. The virtual airtime card application 155 may be preinstalled, downloaded from an application store, and/or the like. The virtual airtime card application 155 may be configured to generate a virtual airtime card. As described in further detail below, there are numerous ways that a virtual airtime card can be generated by the virtual airtime card application 155 implemented by the processor 114.

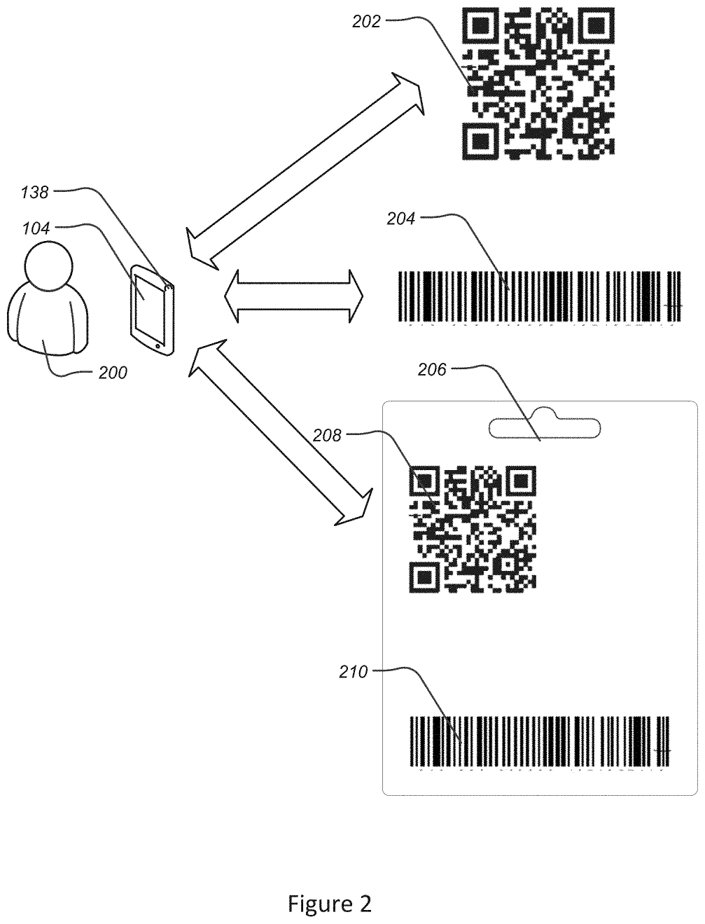

FIG. 2 illustrates a schematic diagram of exemplary virtual airtime card generation scenarios in accordance with aspects of the disclosure.

In one aspect, at a store, a phone user 200 can generate a virtual airtime card with the wireless device 104 based on operation of the camera 138 of the wireless device 104 and/or through the virtual airtime card application 155. In particular, generating a virtual airtime card using a code found at the retail display.

In this aspect, the phone user 200 can generate a virtual card optically through operation of the camera 138 of the wireless device 104 by capturing a code 202 such as a QR code, a Data Matrix code, and/or the like that is located in a retail display, located on an existing airtime card, located on a retail display shelf, and/or the like with the camera 138. In response to capturing the code 202 with the camera 138, the virtual airtime card application 155 can generate a virtual airtime card that includes an image of the virtual airtime card and the phone user 200 can then take this image of the virtual airtime card displayed on the display 118 of the wireless device 104 and purchase it at the point-of-sale. This is particularly useful if the store is out of physical airtime cards.

In an alternative implementation of this aspect, the phone user 200 can generate a virtual card optically through the camera 138 of the wireless device 104 by capturing a code 204 such as a bar code, and/or the like that is located in a retail display, located on an existing airtime card, located on a retail display shelf, and/or the like. In response to capturing the code 204, the virtual airtime card application 155 can generate a virtual airtime card that includes an image of the virtual airtime card and the phone user 200 can then take this image of the virtual airtime card displayed on the display 118 of the wireless device 104 and purchase it at the point-of-sale. This is again particularly useful if the store is out of physical airtime cards.

In an alternative implementation of this aspect, the phone user 200 can generate a virtual card optically through the camera 138 of the wireless device 104 by capturing the code 202 such as a QR code, a Data Matrix code, and/or the like that is located in a retail display, located on an existing airtime card, located on a retail display shelf, and/or the like. The phone user 200 can then take this image captured by the camera 138 of the wireless device 104 and purchase it at the point-of-sale. In particular, the phone user 200 can show the image of the code 202 to the clerk at the point-of-sale for purchase. The resulting airtime code may be printed and/or provided to the phone user 200. This is particularly useful if the store is out of physical airtime cards.

In an alternative implementation of this aspect, the phone user 200 can generate a virtual card optically through the camera 138 of the wireless device 104 by capturing the code 204 such as a bar code that is located in a retail display, located on an existing airtime card, located on a retail display shelf, or the like. The phone user 200 can then take this image captured by the camera 138 of the wireless device 104 and purchase it at the point-of-sale. In particular, the phone user 200 can show the image of the code 204 to the clerk at the point-of-sale for purchase. The resulting airtime code may be printed and/or provided to the phone user 200. This is particularly useful if the store is out of physical airtime cards.

In an alternative implementation of this aspect, at the store, a phone user 200 can scan a code 208 and/or a code 210 of a competitor airtime card 206 and the wireless device 104 and/or the virtual airtime card application 155 may generate a comparable airtime card that the phone user 200 can purchase either through the point-of-sale or through the virtual airtime card application 155.

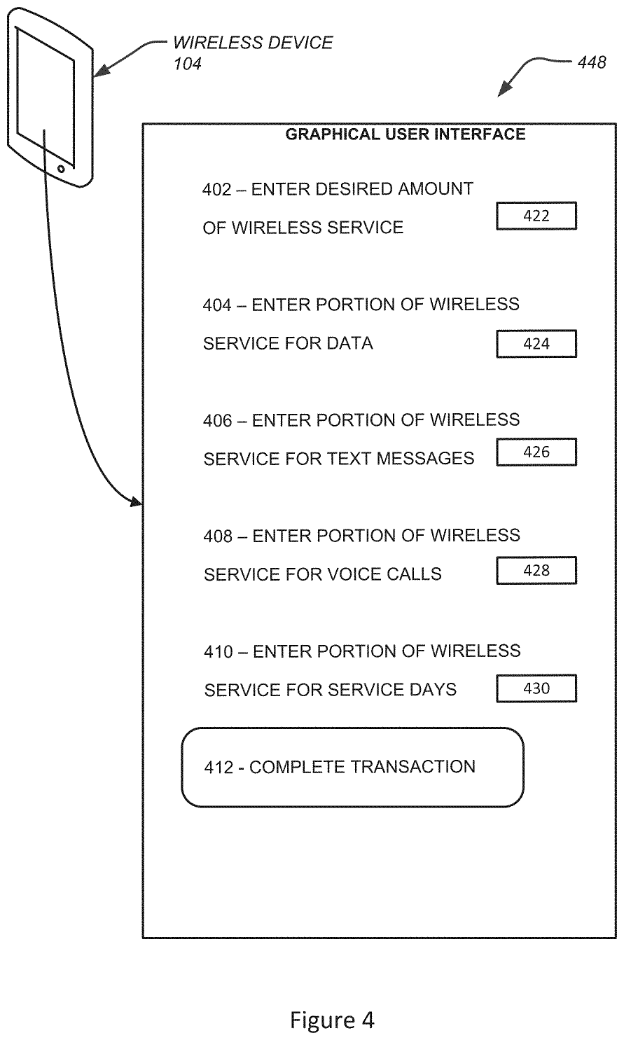

In one aspect, at the store, a phone user 200 may custom create an airtime card using various wireless benefits options based on a specified monetary amount and then purchase the virtual airtime card through the point-of-sale or through the virtual airtime card application 155. In one aspect, at the store, a phone user 200 may custom create an airtime card based on a specified monetary amount and then purchase the virtual airtime card through the point-of-sale or through the virtual airtime card application 155. Thereafter, the phone user 200 can specify the various wireless benefits options to be associated with the virtual airtime card. This aspect is further described in detail below with reference to FIG. 4. Additionally, the various aspects illustrated in FIG. 2 and described above in relation to FIG. 2 may be implemented in any other aspect described in the disclosure. Moreover, any other aspect described in the disclosure may be implemented in aspects illustrated in FIG. 2 described above in relation to FIG. 2.

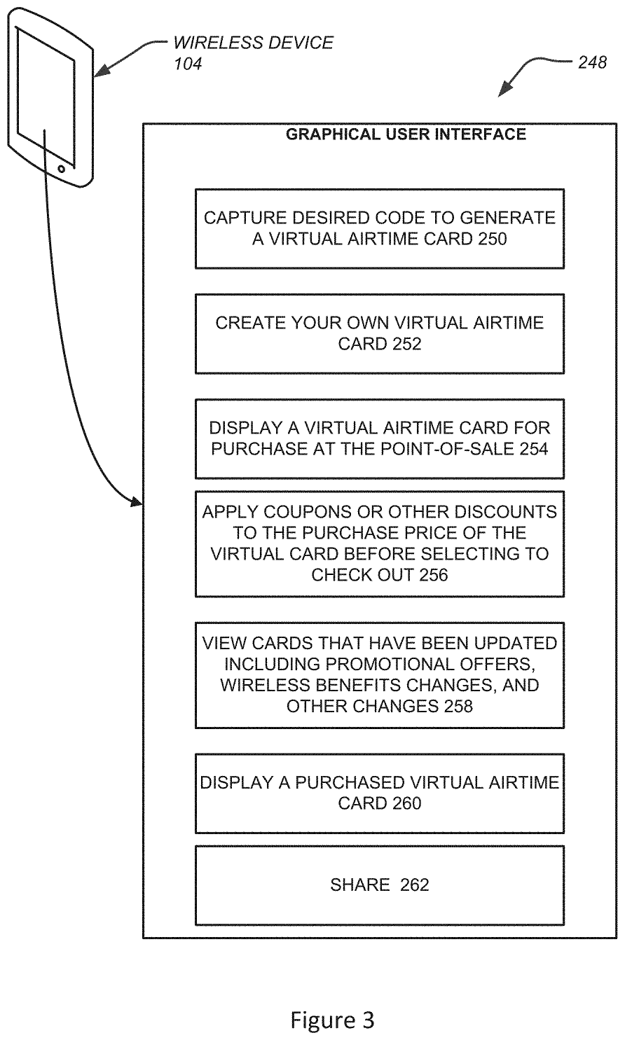

FIG. 3 illustrates a graphical user interface in accordance with aspects of the disclosure.

In this regard, the virtual airtime card application 155 may generate a graphical user interface 248 on the wireless device 104. The graphical user interface 248 may include one or more virtual buttons to control the virtual airtime card application 155 to implement the various features of the disclosure as described above.

In one aspect, a first virtual button 250 may be generated by the virtual airtime card application 155 and displayed on the graphical user interface 248. The first virtual button 250 may be selected by the phone user 200 to capture a desired code to generate a virtual airtime card as described herein. In this aspect, operation of the first virtual button 250 may launch the camera 138 of the wireless device 104. Further, the processor 114 implementing the virtual airtime card application 155 may recognize the code 202, the code 204, the code 208, the code 210, and/or any other type machine-readable code, and identify particular wireless services associated with the machine-readable code and generate the virtual airtime card. In some aspects, the wireless device 104 may also connect with the wireless backend system 722 to obtain additional information for the generation of the virtual airtime card. The additional information may include cost, taxes, wireless service type, wireless carrier, and/or the like.

In one aspect, a second virtual button 252 may generated by the virtual airtime card application 155 and displayed on the graphical user interface 248. The second virtual button 252 may be selected by the phone user 200 to create a customized virtual airtime card as described herein. This aspect is further described in detail below with reference to FIG. 4.

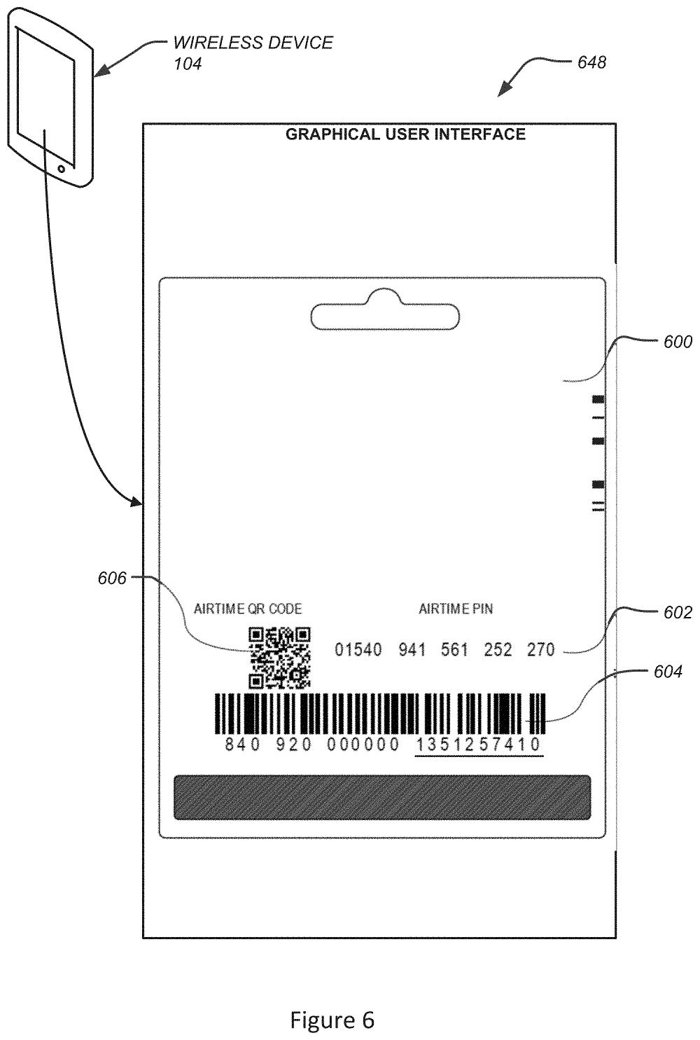

In one aspect, a third virtual button 254 may generated by the virtual airtime card application 155 and displayed on the graphical user interface 248. The third virtual button 254 may be selected by the phone user 200 to display a virtual airtime card for purchase at the point-of-sale as described herein. This aspect is further described in detail below with reference to FIG. 6. Additionally, when displaying a virtual airtime card for purchase at the point-of-sale, the display 118 of the wireless device 104 may provide a purchase price with or without tax, a total price, and/or the like that may be based on a location of the purchase of the virtual airtime card. In this regard, the location determination device 130 may be utilized in determining taxes for a particular location, discounts for particular location, and/or the like.

In one aspect, a fourth virtual button 256 may generated by the virtual airtime card application 155 and displayed on the graphical user interface 248. The fourth virtual button 256 may be selected by the phone user 200 to apply coupons or other discounts to the purchase price of the virtual card before selecting to check out at the point-of-sale. In some aspects, the wireless device 104 may also connect with the wireless backend system 722 to obtain additional information for the generation of the virtual airtime card in order to apply coupons or other discounts to the purchase price of the virtual card. In this regard, the location determination device 130 may be utilized in determining discounts for a particular location, coupons for particular location, and/or the like.

In one aspect, a fifth virtual button 258 may generated by the virtual airtime card application 155 and displayed on the graphical user interface 248. The fifth virtual button 258 may be selected by the phone user 200 to view cards that have been updated to include promotional offers, wireless benefits changes, and/or other changes. In some aspects, the wireless device 104 may also connect with the wireless backend system 722 to obtain additional information for the generation of the virtual airtime card in order to include the promotional offers, the wireless benefits changes, and/or other the changes.

In one aspect, a sixth virtual button 260 may generated by the virtual airtime card application 155 and displayed on the graphical user interface 248. The sixth virtual button 260 may be selected by the phone user 200 to display a purchased virtual airtime card. This aspect is further described in detail below with reference to FIG. 6.

In one aspect, a seventh virtual button 262 may generated by the virtual airtime card application 155 and displayed on the graphical user interface 248. The seventh virtual button 262 may be selected by the phone user 200 to share a purchased virtual airtime card. In this regard, the phone user 200 may be purchasing the virtual airtime card for a friend, a spouse, a family member, and/or the like and may share the purchased virtual airtime card via email, text message, airdrop, social media application, and/or the like.

In another aspect, associated with the seventh virtual button 262, the phone user 200 may share a purchase experience associated with the purchase of the virtual airtime card via a social media application in a social media network. Sharing the purchase experience relating to the virtual airtime card may act as a form of advertising. This may be tracked by the wireless device 104, the virtual airtime card application 155, the wireless backend system 722, and/or the like. Moreover, the tracking of the sharing of the purchase experience may generate discounts for the phone user 200. Accordingly, sharing the purchase experience relating to the virtual airtime card may provide benefits to the phone user 200 such as the discounts as they relate to the advertising in conjunction with the wireless provider and/or the virtual airtime card.

In a further aspect, the virtual airtime card application 155 displayed on the graphical user interface 248 may operate to analyze the wireless service associated with the virtual airtime card that is being generated. In this regard, the virtual airtime card application 155 may provide suggested alternative variations to the wireless service provided by the virtual airtime card application 155 to the phone user 200. In other words, the virtual airtime card application 155 may be configured to provide suggested alternatives that may be more beneficial to the phone user 200 based on cost, historical use, and/or the like. In this regard, the wireless device 104, the virtual airtime card application 155, the wireless backend system 722, and/or the like may implement an algorithm, a simulation, artificial intelligence, machine learning, and/or the like to ascertain future wireless costs to provide suggested alternatives that may be more beneficial to the phone user 200. In this regard, the algorithm, the simulation, the artificial intelligence, the machine learning, and/or the like may operate as a function of historical use of voice call service, data service, text messaging service, and/or service days. The artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

In some aspects, the first virtual button 250, the second virtual button 252, the third virtual button 254, the fourth virtual button 256, the fifth virtual button 258, the sixth virtual button 260, and/or the seventh virtual button 262 may be implemented alternatively as inputs responsive to voice commands utilizing a voice recognition software implemented by the virtual airtime card application 155 and the processor 114 of the wireless device 104. Additionally, the various aspects illustrated in FIG. 3 and described above in relation to FIG. 3 may be implemented in any other aspect described in the disclosure. Moreover, any other aspect described in the disclosure may be implemented in aspects illustrated in FIG. 3 described above in relation to FIG. 3.

FIG. 4 illustrates a graphical user interface in accordance with aspects of the disclosure.

In particular, FIG. 4 illustrates an exemplary graphical user interface 448 of the wireless device 104 implementing the virtual airtime card application 155 for generating a custom virtual airtime card. In one aspect, the graphical user interface 448 may generate a graphical user interface that includes a query to enter an amount of desired wireless service in dollars 402 (or other type of currency) along with an input 422 to receive the amount. The input 422 may allow for numerical values of currency to be entered, may include a drop-down list of preset values of currency, may include radio buttons, and/or the like.

In one aspect, the graphical user interface 448 may generate a graphical user interface that includes a query to enter a portion of wireless service for data 404 along with an input 424 to receive the amount. The input 424 may allow for numerical values of data service to be entered, may include a drop-down list of preset values of data service, may include radio buttons, and/or the like. The input 424 may allow for a percentage of the total wireless service to be allocated to data.

In one aspect, the graphical user interface 448 may generate a graphical user interface that includes a query to enter a portion of wireless service for text messages 406 along with an input 426 to receive the amount. The input 426 may allow for numerical values of text messages to be entered, may include a drop-down list of preset values of text messages, may include radio buttons, and/or the like. The input 426 may allow for a percentage of the total wireless service to be allocated to text messages.

In one aspect, the graphical user interface 448 may generate a graphical user interface that includes a query to enter a portion of wireless service for voice calls 408 along with an input 428 to receive the amount. The input 428 may allow for numerical values of voice calls to be entered, may include a drop-down list of preset values of voice calls, may include radio buttons, and/or the like. The input 428 may allow for a percentage of the total wireless service to be allocated to voice calls.

In one aspect, the graphical user interface 448 may generate a graphical user interface that includes a query to enter a portion of wireless service for service days 410 along with an input 430 to receive the amount. The input 430 may allow for numerical values of service days to be entered, may include a drop-down list of preset values of service days, may include radio buttons, and/or the like. The input 430 may allow for a percentage of the total wireless service to be allocated to service days.

In one aspect, the graphical user interface 448 may generate a graphical user interface that includes an input to complete the transaction 412 and generate the virtual airtime card. In another aspect, the graphical user interface 448 may be utilized to allocate wireless service for an already purchased virtual airtime card. In other words, the phone user 200 may purchase the virtual airtime card at a set or designated amount and subsequently allocate wireless service in desired amounts.

In some aspects, the input 422, the input 424, the input 426, the input 428, and/or the input 430 may be implemented alternatively as inputs responsive to voice commands utilizing a voice recognition software implemented by the virtual airtime card application 155 and the processor 114 of the wireless device 104. Additionally, the various aspects illustrated in FIG. 4 and described above in relation to FIG. 4 may be implemented in any other aspect described in the disclosure. Moreover, any other aspect described in the disclosure may be implemented in aspects illustrated in FIG. 4 described above in relation to FIG. 2.

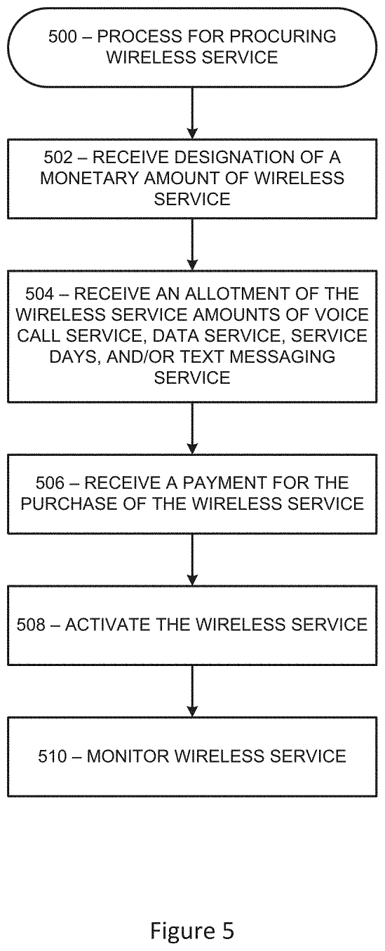

FIG. 5 illustrates an exemplary process that may be used to implement the system of the disclosure.

Referring now to FIG. 5, a process 500 with exemplary process steps is illustrated that may be used for generating a customized virtual airtime card using the virtual airtime card application 155 implemented on the wireless device 104. In other aspects, the virtual airtime card application 155 may be implemented by a server. In this aspect, a browser implemented on the wireless device 104, and/or a browser of an Internet-enabled device (connected devices) according to aspects of the disclosure may generate the virtual airtime card. As illustrated in FIG. 5, the process 500 is shown having an exemplary number of steps and/or an exemplary order of steps. However, the process 500 may include fewer steps, additional steps, and/or a different order of steps.

As illustrated in box 502, the process 500 may receive a designation of a monetary amount of wireless service for a customized virtual airtime card. As illustrated in box 504, the process may also receive an allotment of the wireless service amounts of voice call service, data service, service days, and/or text messaging service. In one aspect, an initial allotment of the wireless service amounts of voice call service, data service, service days, and/or text messaging service may be generated in accordance with the monetary amount of wireless service. In this regard, if the phone user 200 is satisfied with this allotment, no further action is needed to change the allotment of wireless service.

In aspects relating to the virtual airtime card application 155 implemented on the wireless device 104, the monetary amount of wireless service and the allotment the wireless service amounts of voice call service, data service, service days, and/or text messaging service may be entered into a graphical user interface of the virtual airtime card application 155 implemented on the wireless device 104 as illustrated in FIG. 4 and described above.

In some aspects, the determination of the allotment the wireless service amounts of voice call service, data service, service and/or text messaging service based on the monetary amount of wireless service may be determined by a lookup table, an algorithm, artificial intelligence, machine learning, and/or the like. In this regard, the allotment the wireless service amounts of voice call service, data service, service days, and/or text messaging service based on the monetary amount of wireless service may be determined by an algorithm. For example, X dollars of wireless service equals A dollars of voice call service, B dollars of data service, C dollars of service days and/or D dollars of text messaging service. Where X=A+B+C+D. In other words, if the user desires more voice call service, then the user will receive less data service, service days and/or text messaging service for example. The algorithm can operate in real time during the allotment of wireless service. For example, five dollars of wireless service equals two dollars of voice call service, one dollar of data service, one dollar of service days, and one dollar of text messaging service. As another example, five dollars of wireless service equals one dollar of voice call service, two dollars of data service, one dollar of service days, and one dollar of text messaging service. There are of course a great number of different wireless service allotments that a phone user 200 can request. The algorithm can operate in real time such that if the user purchases five dollars of wireless service and designates five dollars for data service, the user cannot designate any voice service, service days, or text messaging service. In other words, they have allocated all of the five dollars to data service.

In another aspect, the algorithm may include an overhead cost, exchange factor, and/or exchange rate. For example, X dollars of wireless service equals A dollars of voice call service, B dollars of data service, C dollars of service days, D dollars of text messaging service, and an exchange rate F. Where X=A+B+C+D+F. In one aspect, the exchange rate F may be a flat cost (i.e., one dollar). For example, five dollars of wireless service equals one dollar of voice call service, one dollar of data service, one dollar of service days, one dollar of text messaging service, and one dollar of overhead. In other aspects, the exchange rate F may be a sliding rate. If implemented as a sliding rate, the sliding rate may equal (X−G)*F, where G is a desired breakeven value. Thus, the wireless user realizes a payment of overhead when the wireless service purchased is less than G and realizes a benefit when the wireless service purchased is greater than G. The resulting algorithm would then be X=A+B+C+D+(X−G)*F.

At box 506, a payment transaction for the purchase of the wireless service may be completed. In aspects relating to a point-of-sale terminal 720, the payment transaction may be made through the point-of-sale terminal 720. In aspects relating to the virtual airtime card application 155, the payment transaction may be made through the graphical user interface of the virtual airtime card application 155 implemented on the wireless device 104. Payment may include credit card payment, debit card payment, cash payment, electronic check, check, payment applications, store gift card, and the like. Payment applications can include but are not limited to, for example, Google Wallet™, PayPal™, Amazon Payments™, and the like. Accordingly, the payment processing can receive payment through a salesperson, a payment application, or the like.

Thereafter, the wireless backend system 722 may receive the designated monetary amount of wireless service and optionally the allotment of the wireless service amounts of voice call service, data service, service days, and/or text messaging service associated with the virtual airtime card. The monetary amount of wireless service and allotment of the wireless service amounts of voice call service, data service, service days, and/or text messaging service may be associated with a unique identifier stored in a database of the wireless backend system 722. The unique identifier may be associated with an airtime code, or the like that may be provided to the phone user 200 with the virtual airtime card 600, the unique identifier may be a personal identification number (PIN).

At box 508, the phone user 200 may elect to activate the wireless service at the time of purchase or save the activation code for future use. In one aspect, the unique identifier code along with wireless device 104 information are transmitted to and received by the wireless backend system 722 as described above. The wireless device-related information can include, for example, the International Mobile Equipment Identify (“IMEI”), an Electronic Serial Number (ESN), Mobile Equipment Identifier (MEID), a phone number of the wireless device 104, and/or a serial number for a Subscriber Identity Module (SIM) card installed in the wireless device 104. The SIM card may include a SIM card memory for storing at least a SIM card serial number, for example, an Integrated Circuit Card ID (ICCID). A wireless device not utilizing a SIM card is contemplated as well for use with the disclosure.

The wireless backend system 722 may verify the unique identification code by searching for the unique identification code in one or more databases to ensure the unique identification code has not been recorded/redeemed previously. If the wireless backend system 722 finds the unique identification code is not approved, the activation of the wireless service will be stopped. Upon stopping the activation of the wireless service, the wireless backend system 722 may send a warning message to the phone user 200 (e.g., using the wireless device 104) and/or the wireless provider.

Alternatively, if the unique identification code is approved (authentic, not been previously used, or the like) by the wireless backend system 722, authorization of a wireless service, including an update of the user's prepaid account, may take place. In this regard, the authorized unique identification code may be recorded in a database of the wireless backend system 722 before, after, or during, the activation of the wireless service on the wireless device 104 takes place. In other aspects, the authorization of wireless service may be completed without utilizing a unique identifier.

In some aspects, information may be transferred in the form of an activation message that corresponds and/or includes the wireless provider and/or wireless service selection by the phone user 200 and automatically retrieved wireless device related information, the wireless device 104 unique identifier, and/or payment information, payment authorization information, payment verification information, and the like. The activation message including the automatically retrieved information can be generated by a processor including, for example, the processor of the wireless device 104, internet-enabled device, and/or a processor at the point-of-sale terminal 720. In some aspects, the activation message may be transmitted over a provisioning channel or communication channel 724 provided over a provisioning wireless carrier network 716 that is available to inactive or unprovisioned wireless devices or via any type of conventional activation protocols known in the art on a communication channel as defined herein. Alternatively, the activation message can be transmitted from the point-of-sale terminal 720 via any wired or other wireless communication type to the wireless backend system 722. The wireless backend system 722 can include one or more servers, one or more databases, and the like wherein authorized unique identifiers of a wireless device 104 may be correlated, recorded, tracked, and the like when a wireless service is purchased, redeemed, and/or the like.

Although it is not required in some aspects, the provisioning wireless carrier network 716 may be used to receive the activation message via a the communication channel 724 and forward the activation message in real time to a provisioning wireless carrier network 716 operated by a service provider for the activation of one or more services for the wireless device 104. Accordingly, the services requested to be activated can include at least one of: an initial “out of the box” activation of wireless services of an unprovisioned wireless device 104 or device upgrades, device reactivation, wireless number changes, the addition or purchasing of services including airtime, enrollments or content, and wireless number porting for wireless devices that have previously been activated or provisioned. In some aspects, the provisioning wireless carrier network 716 can be connected to a wireless carrier server and forward the activation message to the provisioning wireless carrier network 716, either directly or through a destination server connected to the provisioning wireless carrier network 716, to initiate service activation and provisioning of the wireless device 104.

As illustrated in box 510, the use of the wireless service activated may be monitored to determine when the corresponding wireless service has been expended by the phone user 200. The wireless services may be monitored by a metering system as described in the disclosure. Additionally, the various aspects illustrated in FIG. 5 and described above in relation to FIG. 5 may be implemented in any other aspect described in the disclosure. Moreover, any other aspect described in the disclosure may be implemented in aspects illustrated in FIG. 5 described above in relation to FIG. 5.

FIG. 6 illustrates a graphical user interface for displaying a virtual airtime card in accordance with aspects of the disclosure.

In particular, FIG. 6 illustrates that the virtual airtime card application 155 may generate a graphical user interface 648 on the display 118 of the wireless device 104. The graphical user interface 648 may include displaying the virtual airtime card 600. In one aspect, the virtual airtime card 600 may be generated to visually look like a real airtime card. In one aspect, the virtual airtime card 600 may be generated to have artwork. In one aspect, the virtual airtime card 600 may be generated to include wireless service provider name and identifying information. In one aspect, the virtual airtime card 600 may be generated to include an airtime PIN 602 (personal identification number). In one aspect, the virtual airtime card 600 may be generated to include a barcode 604 configured to be read by a point-of-sale system or another wireless device. In one aspect, the virtual airtime card 600 may be generated to include a QR Code 606 configured to be read by a point-of-sale system or another wireless device.

In one aspect, the virtual airtime card 600 displayed on the display 118 of the wireless device 104 may be used at the point-of-sale to purchase the virtual airtime card 600. In this regard, the phone user 200 after generating the virtual airtime card 600 may take the virtual airtime card 600 displayed on the wireless device 104 to the point-of-sale. The point-of-sale terminal 720 may read the QR Code 606 or the barcode 604 (machine readable codes) and authorize the virtual airtime card through the wireless backend system 722 as described herein. Additionally, the various aspects illustrated in FIG. 6 and described above in relation to FIG. 6 may be implemented in any other aspect described in the disclosure. Moreover, any other aspect described in the disclosure may be implemented in aspects illustrated in FIG. 6 described above in relation to FIG. 6.

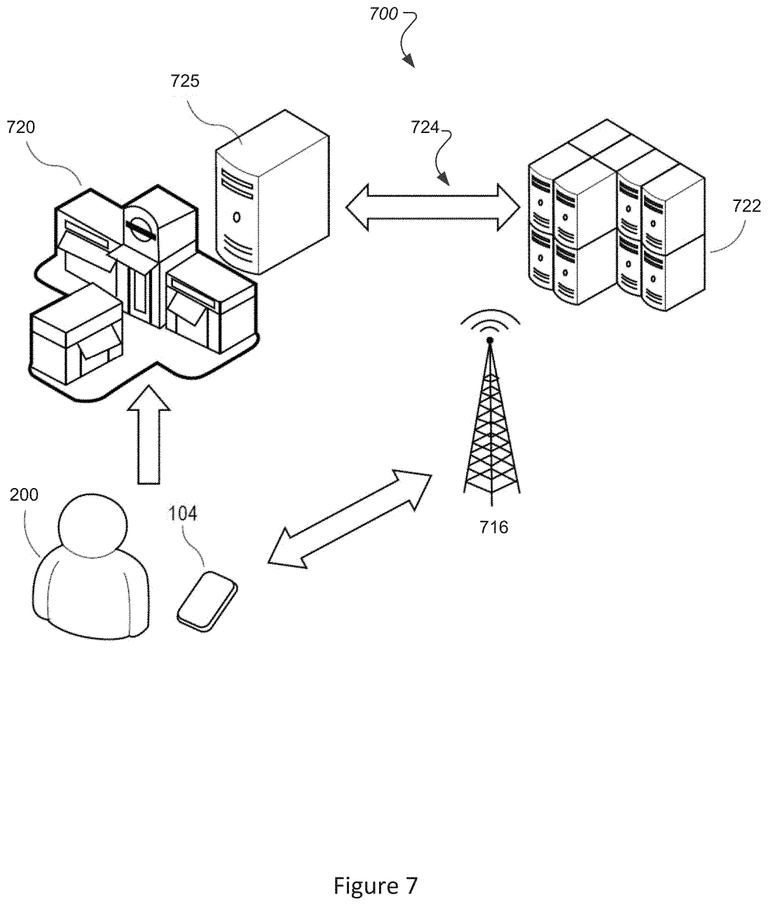

FIG. 7 illustrates an exemplary system according to aspects of the disclosure.

In particular, a wireless service provisioning system 700 can be used to purchase, procure, add, activate, authorize, provision and/or the like wireless services on a wireless device 104, which will be referred to as procuring wireless service for brevity hereinafter. In one aspect, the wireless service provisioning system 700 can be used to procure wireless services for a prepaid account of the wireless device 104. In one aspect, the wireless service provisioning system 700 can be used to procure wireless services for a prepaid account of the wireless device 104 utilizing the virtual airtime card 600.

The phone user 200 may be able to procure wireless service by purchasing the virtual airtime card at a point-of-sale terminal 720, by purchasing the virtual airtime card with the virtual airtime card application 155, or the like. For example, the phone user 200 may be able to procure wireless service by generating the virtual airtime card 600 as described herein. Thereafter, the phone user 200 may present the virtual airtime card 600 at the point-of-sale terminal 720 and purchase the virtual airtime card 600. In another aspect, the phone user 200 may generate the virtual airtime card 600 and purchase the virtual airtime card 600 with the virtual airtime card application 155.

The point-of-sale terminal 720 may include one or more of the various features of the wireless device 104 described in relation to FIG. 1. In this regard, the point-of-sale terminal 720 may be any type of computing device, such as, a desktop computer, personal computer, a laptop/mobile computer, a personal data assistant (PDA), a mobile phone, a tablet computer, cloud computing device, and the like, with wired/wireless communications capabilities via the communication channels.

An indication that the virtual airtime card 600 has been purchased may then be transmitted to the wireless backend system 722. In this aspect, the wireless backend system 722 may receive one or more of the airtime PIN 602, the barcode 604, the QR Code 606, or the like associated with the virtual airtime card 600 from the point-of-sale terminal 720 and store the same in a database for future redemption. In one aspect, the wireless backend system 722 may receive one or more of the airtime PIN 602, the barcode 604, the QR Code 606, or the like associated with the virtual airtime card 600 from the wireless device 104 utilizing an in application purchase implemented by the virtual airtime card application 155 and store the same in a database for future redemption. The airtime PIN 602, the barcode 604, the QR Code 606 associated with the virtual airtime card 600 relating to an amount of voice call service, data service, text messaging service, and/or service days.

In one aspect, identifying information of the virtual airtime card 600 may be input into a communication system 725 and transmitted over a communication channel 724 to the wireless backend system 722. The identifying information may be an identification number listed on the airtime card, the airtime PIN 602, the barcode 604, the QR Code 606 associated with the virtual airtime card 600 relating to an amount of voice call service, data service, text messaging service, and/or service days.

Thereafter, the virtual airtime card 600 may be used by the phone user 200 to obtain wireless services. In this regard, the phone user 200 may utilize the airtime card/airtime code and an associated unique identifier or personal identification number (PIN) for procuring the desired wireless service. In this regard, the phone user 200 may input the unique identifier into the wireless device 104 or an internet-enabled device for transmission to a wireless backend system 722 for the provisioning of the wireless service associated with the virtual airtime card. Thereafter, the wireless backend system 722 may update the prepaid account of the phone user 200 consistent with the amount of wireless service obtained and the particular distribution of wireless services.

In one aspect, the phone user 200 may input the unique identifier into the wireless device 104 utilizing the virtual airtime card application 155 that transmits the code to the wireless backend system 722. Thereafter, the wireless backend system 722 may update the prepaid account of the phone user 200 consistent with the amount of wireless service obtained by the virtual airtime card.

In one aspect, the phone user 200 may input the unique identifier into the wireless device 104 utilizing a web browser that launches a web portal implemented by the wireless backend system 722 that transmits the code to the wireless backend system 722. Thereafter, the wireless backend system 722 may update the prepaid account of the phone user 200 consistent with the amount of wireless service obtained by the virtual airtime card.

In one aspect, the phone user 200 may input the unique identifier into the wireless device 104 utilizing a text messaging application addressed to a designated short code that transmits the code to the wireless backend system 722. In this regard, in some aspects, the wireless backend system 722 may send various text messages to the phone user 200 confirming receipt of the unique identifier. Thereafter, the wireless backend system 722 may update the prepaid account of the phone user 200 consistent with the amount of wireless service obtained by the virtual airtime card.

In one aspect, the phone user 200 may input the unique identifier into the internet-enabled device utilizing a web browser that launches a web portal implemented by the wireless backend system 722 that transmits the code to the wireless backend system 722. Thereafter, the wireless backend system 722 may update the prepaid account of the phone user 200 consistent with the amount of wireless service obtained by the virtual airtime card.

In one aspect, the phone user 200 may input the unique identifier into the wireless device 104 during a phone call to an Interactive Voice Response (IVR) system implemented by the wireless backend system 722 to deliver the unique identifier to the wireless backend system 722. Thereafter, the wireless backend system 722 may update the prepaid account of the phone user 200 consistent with the amount of wireless service obtained by the virtual airtime card.

The resulting wireless service provided to the wireless device 104 by a wireless network utilizing the virtual airtime card may be monitored by an internal accounting module in the wireless device 104, by a metering device implemented by the wireless network, by both the internal accounting module in the wireless device 104 and the metering device implemented by the wireless network, or the like. For brevity, each of the above-noted implementations, which are described in detail below, will be referred to as a metering system.

In one aspect, the wireless device 104 may utilize an internal accounting module to establish an account with a representation of prepaid funds or available credit for wireless services. In some aspects, the internal accounting module of the wireless device 104 may also be used to store and/or transmit a plurality of charge rates as well as a billing/payment algorithm. The internal accounting module can monitor and classify each wireless service used (voice call service, data service, text messaging service, and service days) into one of a plurality of billing categories. Select a charge rate corresponding to that billing category. Calculate an appropriate charge for the voice call service, data service, text messaging service, and service days in real time by using the selected charge rate. Finally, apply this charge to a prepaid account. Thereafter, the resulting wireless service usage is debited from the prepaid account. Additionally, the amount in the prepaid account can be increased as described herein.

In other aspects, the wireless device 104 and the wireless network may forma hybrid system that together or individually monitor the wireless service utilized by the wireless device. In this regard, the hybrid system may store and/or transmit a plurality of charge rates as well as a billing/payment algorithm. The hybrid system can monitor and classify each wireless service used (voice call service, data service, text messaging service, and service days) into one of a plurality of billing categories. Select a charge rate corresponding to that billing category. Calculate an appropriate charge for the data usage, voice usage, service days, and SMS usage in real time by using the selected charge rate. Finally, apply this charge to a prepaid account. In other words, the resulting wireless service usage is debited from the prepaid account. Additionally, the amount in the prepaid account can be increased as described herein. In this aspect, the disclosure may utilize the teachings of U.S. patent application Ser. No. 13/669,838, filed Nov. 6, 2012, titled Hybrid Network Based Metering Server and Tracking Client for Wireless Services by the assignee of the present disclosure, which is incorporated by reference in its entirety.

In yet other aspects, the wireless network may monitor the wireless service utilized by the wireless device 104. This aspect may be implemented in a MNO, MVNO, or both types of wireless networks. In this regard, the wireless network may store and/or transmit a plurality of charge rates as well as a billing/payment algorithm. The wireless network can monitor and classify each wireless service used (voice call service, data service, text messaging service, and service days) into one of a plurality of billing categories. Select a charge rate corresponding to that billing category. Calculate an appropriate charge for the data usage, voice usage, service days, and SMS usage in real time by using the selected charge rate. Finally, apply this charge to a prepaid account. In other words, the resulting wireless service usage is debited from the prepaid account. Additionally, the amount in the prepaid account can be increased as described herein. In this aspect, the disclosure may utilize the teachings of U.S. patent application Ser. No. 15/215,985, filed Jul. 21, 2015, titled System, Process And Device For Multiple Network Usage Tracking by the assignee of the present disclosure, which is incorporated by reference in its entirety.

In some aspects, once it is determined that the amount of wireless service (voice call service, data service, text messaging service, and/or service days) used has depleted the account to zero, the processor 114 may interact with the internal accounting module and/or the wireless backend system 722 to limit, prevent, alert the user, and/or control further use of the wireless device 104. In some aspects, once the wireless network determines that the amount of wireless service (data, voice, service days, and/or SMS) used has depleted the account to zero, the wireless backend system 722 may limit, prevent, alert the user, and/or control further use of the wireless device 104 as further described herein.

The controlled use can include suspending voice calls, allowing limited voice calls, allowing all voice calls, suspending text messages, allowing limited text messages, allowing all text messages, suspending wireless data service, limiting wireless data service, throttling wireless data service, and allowing all wireless data service. Additionally, the various aspects illustrated in FIG. 7 and described above in relation to FIG. 7 may be implemented in any other aspect described in the disclosure. Moreover, any other aspect described in the disclosure may be implemented in aspects illustrated in FIG. 7 described above in relation to FIG. 7.

Accordingly, a more convenient and flexible approach has been disclosed for the sale and procuring of wireless services through a virtual airtime card. Additionally, through geolocation, the disclosed virtual airtime card application can better estimate the price based on local tax rates. In addition, the disclosed virtual airtime card application can provide discounts that can be generated based on customer location. Moreover, common problems with physical airtime cards including: managing inventory, wireless benefits offering changes of the cards, price-point changes of the cards, and/or managing multiple cards with various combinations or wireless benefits offerings may be easily addressed by the virtual airtime card application.

Additionally, the virtual airtime card can be sent electronically to anyone via numerous methods (i.e. text, email, airdrop, etc.). Moreover, the customer can retain an image of the virtual card to either purchase via app or through the POS. Additionally, the customer can send invitations to anyone to view virtual card sales or other promotional offers. Moreover, the customer can view cards that have been updated including promotional offers, wireless benefits changes, and other changes.

Additionally, the phone user may be able to designate an amount of wireless service desired in any amount. This approach gives the phone user 200 great flexibility to obtain the desired wireless service consistent with their budget, needs, and so on.

With the disclosed virtual airtime card application, the customer can apply coupons or other discounts to the purchase price of the virtual card before selecting to check out. Finally, virtual card purchases provide enhanced visibility enabling a MVNO to better manage the customer account by suggesting airtime cards with better value to the customer including sending a new or replacement SIM card if deemed to provide better wireless coverage. Accordingly, a more convenient flexible approach has been provided for the sale and procuring of wireless services.

In one aspect, the virtual airtime card described in the disclosure may be defined as a digital image generated by a wireless application and displayed on a display of a device such as a wireless device, the digital image including a code utilizable to obtain wireless services. In one aspect, the virtual airtime card described in the disclosure may be defined as a digital image generated by a wireless application and displayed on a display of a device such as a wireless device. In one aspect, the virtual airtime card described in the disclosure may be defined as a digital image generated by a wireless application and displayed on a display of a device such as a wireless device, the digital image including a code representative of a monetary value. In one aspect, the virtual airtime card described in the disclosure may be defined as an image generated by a wireless application and displayed on a display of a device such as a wireless device, the image including a code representative of a monetary value. In one aspect, the virtual airtime card described in the disclosure may be defined as an image generated by a wireless application and displayed on a display of a device such as a wireless device, the image including a code utilizable to obtain wireless services.

Aspects of the disclosure may be web-based. For example, a server may operate a web application in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be beneficial due to the ubiquity of web browsers and the convenience of using a web browser as a client (i.e., thin client). Further, with inherent support for cross-platform compatibility, the web application may be maintained and updated without distributing and installing software on each.

The web portal may be a specially designed website that brings information from diverse sources. In some aspects, each information source gets a dedicated area on the page for displaying information (a portlet). In some aspects, the portal may include mashups and intranet “dashboards.” The portal may use an application programming interface (API). The portal may provide a way for enterprises and organizations with access control, modification, procedures, and the like for multiple applications and databases. The features available may be restricted to an authorized and authenticated user (employee, member).

The term text messaging service, text message, or SMS refers to “short message service” which is a text messaging service component of phone, web, or mobile communication systems. It uses standardized communications protocols to allow fixed line or mobile phone devices to exchange short text messages. SMS was originally designed as part of GSM, but is now available on a wide range of networks, including 3G, 4G, LTE, and 5G networks or networks associated with the communication channel as defined herein. In other aspects, text message may include Multimedia Messaging Service (MMS), which is a standard way to send messages that include multimedia content to and from mobile phones. It extends the core SMS (Short Message Service) capability that allowed exchange of text messages only up to 160 characters in length. While a popular use is to send photographs from camera-equipped handsets, it is also used as a method of delivering news and entertainment content including videos, pictures, text pages, and ringtones. MMS can be used within the context of the present invention for UICC activation message delivery. Of note is that MMS messages are delivered in a completely different way from SMS. The first step is for the sending device to encode the multimedia content in a fashion similar to sending a MIME e-mail (MIME content formats are defined in the MMS Message Encapsulation specification). The message is then forwarded to the carrier's MMS store and forward server, known as the MMSC (Multimedia Messaging Service Centre). If the receiver is on another carrier, the relay forwards the message to the recipient's carrier using the Internet.

The term voice call service, voice, or voice calls as utilized herein may include voice calls defined by 3GPP (3rd Generation Partnership Project) with Voice Call Continuity (VCC) specifications in order to describe how a voice call can be persisted, as a mobile phone moves between circuit switched and packet switched radio domains (3GPP TS 23.206).

The term data service or data as utilized herein includes mobile broadband or wireless Internet access delivered through mobile phone towers over a communication channel as defined herein to computers, mobile phones, wireless devices, and other digital devices as defined herein using portable modems. Some mobile services allow more than one device to be connected to the Internet using a single cellular connection using a process called tethering.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), 5G (fifth generation), W-CDMA (Wideband Code-Division Multiple Access), Wireless Fidelity (Wi-Fi), Bluetooth, Near field communication (NFC), and/or the like, and/or a combination of two or more thereof. The NFC standards cover communications protocols and data exchange formats, and are based on existing radio-frequency identification (RFID) standards including ISO/IEC 14443 and FeliCa. The standards include ISO/IEC 18092[3] and those defined by the NFC Forum.

The disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In an aspect, the disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

The application described in the disclosure may be implemented to execute on an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like. The application may be displayed as an icon. The application may have been downloaded from the Internet, pre-installed, or the like. In some aspects, the application may be obtained from Google Play™, Android Market™, Apple Store™, or the like digital distribution source. The application may be written in conjunction with the software developers kit (SDK) associated with an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various embodiments of the disclosure, the methods described herein are intended for operation with dedicated hardware implementations including, but not limited to, PCs, PDAs, semiconductors, Application Specific Integrated Circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

For the purposes of this disclosure a computer readable medium stores computer data, which data can include computer program code that is executable by a processor in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and nonremovable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage media, magnetic cassettes, magnetic tape, magnetic disk storage or other magnetic storage devices, or any other physical or material medium which can be used to tangibly store the desired information or data or instructions and which can be accessed by a processor or computing device. In one or more aspects, the actions and/or events of a method, algorithm, or module may reside as one or any combination or set of codes and/or instructions on a computer readable medium or machine readable medium, which may be incorporated into a computer program product.

As used herein interactive voice response (IVR) is a technology that allows a computer to interact with humans through the use of voice and DTMF tones input via keypad. In telecommunications, IVR allows customers to interact with a host system via a telephone keypad or by voice recognition, after which they can service their own inquiries by following the IVR dialogue. IVR systems can respond with prerecorded or dynamically generated audio to further direct users on how to proceed. IVR applications can be used to control almost any function where the interface can be broken down into a series of simple interactions.

Voice recognition software may be utilized in various aspects of the systems and methods. Users may be able to vocalize, rather than utilizing other input processes. For example, the voice recognition software may be configured for generating text from voice input from a microphone or other voice input. A speech signal processor may convert speech signals into digital data that can be processed by the processor. The processor may perform several distinct functions, including serving as the speech event analyzer, the dictation event subsystem, the text event subsystem, and the executor of the application program. The speech signal processor may generate speech event data and transmit this data to the processor to be processed first by the speech event analyzer. The speech event analyzer may generate a list or set of possible candidates among the system recordings that represent or match the voice input processed by the speech signal processor. The speech event analyzer may transmit the candidate sets to a dictation event subsystem. The dictation event subsystem may analyze the candidate sets and choose the best match candidate with the highest degree of similarity. This candidate is then considered the correct translation, and the dictation event subsystem forwards the translation to the text event subsystem which in turn inputs the translated text into the device.

According to an example, the global navigation satellite system (GNSS) may include a device and/or system that may estimate its location based, at least in part, on signals received from space vehicles (SVs) for the wireless device 104. In particular, such a device and/or system may obtain “pseudorange” measurements including approximations of distances between associated SVs and a navigation satellite receiver. In a particular example, such a pseudorange may be determined at a receiver that is capable of processing signals from one or more SVs as part of a Satellite Positioning System (SPS). Such an SPS may include, for example, a Global Positioning System (GPS), Galileo, Glonass, to name a few, or any SPS developed in the future. To determine its location, a satellite navigation receiver may obtain pseudorange measurements to three or more satellites as well as their positions at time of transmitting. Knowing the SV orbital parameters, these positions can be calculated for any point in time. A pseudorange measurement may then be determined based, at least in part, on the time a signal travels from an SV to the receiver, multiplied by the speed of light. While techniques described herein may be provided as implementations of location determination in GPS and/or Galileo types of SPS as specific illustrations according to particular examples, it should be understood that these techniques may also apply to other types of SPS, and that claimed subject matter is not limited in this respect.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A wireless service provider system for authorizing wireless service on a wireless device, the wireless device comprising:
a processor configured to implement a virtual airtime card application;
a camera configured to capture an image of an airtime card code;
the processor further configured to implement the virtual airtime card application to generate a virtual airtime card based on the image of the airtime card code; and
a display configured to display the virtual airtime card generated by the processor, wherein:
the virtual airtime card displayed on the display of the wireless device is configured to be purchased with at least one of the following: a point-of-sale or through a payment process implemented by the virtual airtime card application.

2. The wireless service provider system of claim 1, wherein the virtual airtime card comprises at least one code configured to be provided to a wireless service provider system to authorize wireless service for a wireless device.

3. The wireless service provider system of claim 1, further comprising:
a backend system configured to be in communication with a connected device; and
the backend system further configured to receive a request to activate at least one code of the virtual airtime card,
wherein the connected device comprises one of the following: a point-of-sale terminal, the wireless device, or an Internet-enabled device.

4. The wireless service provider system of claim 3, further comprising:
a metering system configured to monitor a use of the wireless service provided by a wireless service provider used by the wireless device; and
the metering system further configured to control the use of the wireless service provided by the wireless service provider used by the wireless device.

5. The wireless service provider system of claim 1, further comprising:
a backend system configured to be in communication with a connected device; and
the backend system further configured to receive a request to authorize wireless service in response to receiving at least one code of the virtual airtime card,
wherein the connected device comprises one of the following: a point-of-sale terminal, the wireless device, or an Internet-enabled device.

6. The wireless service provider system of claim 5, further comprising:
a metering system configured to monitor a use of the wireless service provided by a wireless service provider used by the wireless device; and
the metering system further configured to control the use of the wireless service provided by the wireless service provider used by the wireless device.

7. The wireless service provider system of claim 1, further comprising:
a backend system configured to be in communication with a connected device;
the backend system further configured to receive a request to activate at least one code of the virtual airtime card; and
the backend system further configured to receive a request to authorize wireless service in response to receiving the at least one code of the virtual airtime card,
wherein the connected device comprises one of the following: a point-of-sale terminal, the wireless device, or an Internet-enabled device.

8. The wireless service provider system of claim 7, further comprising:
a metering system configured to monitor a use of the wireless service provided by a wireless service provider used by the wireless device; and
the metering system further configured to control the use of the wireless service provided by the wireless service provider used by the wireless device.

9. The wireless service provider system of claim 3, wherein:
the connected device comprises the wireless device; and
the backend system further configured to receive the request for the wireless service along with a monetary value of the wireless service in a requested amount from the wireless device through the virtual airtime card application executed in the processor of the wireless device.

10. The wireless service provider system of claim 9, wherein
the backend system further configured to receive a request from the wireless device for allocating the wireless service from the wireless device through the virtual airtime card application executed in the processor of the wireless device.

11. A wireless service provider system comprising:
a backend system configured to be in communication with a connected device;
the backend system further configured to receive a request to activate at least one code of a virtual airtime card from the connected device;
the backend system further configured to receive a request to authorize wireless service for a wireless device in response to receiving the at least one code of the virtual airtime card;
a metering system configured to monitor a use of the wireless service provided by a wireless service provider used by the wireless device; and
the metering system further configured to control the use of the wireless service provided by the wireless service provider used by the wireless device,
wherein the wireless device comprises a processor configured to implement a virtual airtime card application to generate the virtual airtime card based on an image of an airtime card code, and
wherein the connected device comprises one of the following: a point-of-sale terminal, the wireless device, or an Internet-enabled device.

12. The wireless service provider system of claim 11, further comprising the wireless device and the wireless device comprising a camera configured to capture an image of an airtime card code.

13. The wireless service provider system of claim 12, wherein the processor is further configured to implement the virtual airtime card application to generate a virtual airtime card based on the image of the airtime card code.

14. The wireless service provider system of claim 13, the wireless device further comprising a display configured to display the virtual airtime card generated by the processor.

15. The wireless service provider system of claim 14, wherein the virtual airtime card displayed on the display of the wireless device is configured to be purchased with at least one of the following: a point-of-sale or through a payment process implemented by the virtual airtime card application.

16. The wireless service provider system of claim 11, wherein the virtual airtime card comprises at least one code configured to be provided to a wireless service provider system to authorize wireless service for a wireless device.

17. The wireless service provider system of claim 16, further comprising the wireless device and the wireless device comprising:
a camera configured to capture an image of an airtime card code;
the processor further configured to implement the virtual airtime card application to generate a virtual airtime card based on the image of the airtime card code; and
a display configured to display the virtual airtime card generated by the processor, wherein:
the virtual airtime card displayed on the display of the wireless device is configured to be purchased with at least one of the following: a point-of-sale or through a payment process implemented by the virtual airtime card application; and
the virtual airtime card comprises at least one code configured to be provided to a wireless service provider system to authorize wireless service for a wireless device.

18. The wireless service provider system of claim 12, wherein:
the connected device comprises the wireless device; and
the backend system further configured to receive the request for the wireless service along with a monetary value of the wireless service in a requested amount from the wireless device through the virtual airtime card application executed in the processor of the wireless device.

19. The wireless service provider system of claim 18, wherein
the backend system further configured to receive a request from the wireless device for allocating the wireless service from the wireless device through the virtual airtime card application executed in the processor of the wireless device.

20. A non-transitory computer program product embodying instructions for implementing a process for authorizing wireless service on a wireless device when executed by a processor of the wireless device, the instructions comprising:
implementing a virtual airtime card application in the processor of the wireless device;
capturing an image of an airtime card code with a camera from the wireless device;
generating a virtual airtime card based on the image of the airtime card code with the processor; and
displaying the virtual airtime card generated by the processor on a display of the wireless device, wherein:
the virtual airtime card displayed on the display of the wireless device is configured to be purchased with at least one of the following: a point-of-sale or through a payment process implemented by the virtual airtime card application,
the virtual airtime card comprises at least one code configured to be provided to a wireless service provider system to provision wireless service to a wireless device.
